(19) United States
(12) Patent Application Publication
(10) Pub. No.: US 2014/0133187 A1
(43) Pub. Date: May 15, 2014

(54) ELECTRIC POWER CONVERSION SYSTEM AND FAILURE DETECTION METHOD FOR ELECTRIC POWER CONVERSION SYSTEM

(71) Applicant: Takahiro HIRANO, Toyota-shi (JP)

(72) Inventor: Takahiro HIRANO, Toyota-shi (JP)

(73) Assignee: TOYOTA JIDOSHA KABUSHIKI KAISHA, Toyota-shi (JP)

(21) Appl. No.: 14/072,192

(22) Filed: Nov. 5, 2013

(30) Foreign Application Priority Data
Nov. 9, 2012 (JP) 2012-247828

(51) Int. Cl. H02M 3/335; H02M 1/32

(52) U.S. Cl. CPC H02M 3/33592; H02M 1/32
USPC 363/17

(57) ABSTRACT

An electric power conversion system includes: a primary conversion circuit; a secondary conversion circuit magnetically coupled to the primary conversion circuit via a transformer; and a failure detection unit configured to detect a failure of any one of switching elements by causing each of the switching elements to switch between an on state and an off state. The switching elements constitute a full-bridge circuit of a conversion circuit to which input voltage is supplied from a corresponding one of center taps of the transformer. The full-bridge circuit is one of a primary full-bridge circuit of the primary conversion circuit and a secondary full-bridge circuit of the secondary conversion circuit.

### INCORPORATION BY REFERENCE

The disclosure of Japanese Patent Application No. 2012-247828 filed on Nov. 9, 2012 including the specification, drawings and abstract is incorporated herein by reference in its entirety.

### BACKGROUND OF THE INVENTION

1. Field of the Invention

The invention relates to an electric power conversion system that includes a primary conversion circuit and a secondary conversion circuit magnetically coupled to the primary conversion circuit via a transformer, and a failure detection method for the electric power conversion system.

2. Description of Related Art

For example, Japanese Patent Application Publication No. 2011-193713 (JP 2011-193713 A) is known as a related art document regarding an electric power conversion system that includes a primary conversion circuit and a secondary conversion circuit magnetically coupled to the primary conversion circuit via a transformer. In JP 2011-193713 A, the primary conversion circuit and the secondary conversion circuit each have a full-bridge circuit.

### SUMMARY OF THE INVENTION

Incidentally, in the related art, it is difficult to implement failure detection each of switching elements that constitute the primary full-bridge circuit and the secondary full-bridge circuit with a simple configuration. The invention provides an electric power conversion system and a failure detection method for an electric power conversion system, which are able to detect a failure of any one of the switching elements that constitute the primary full-bridge circuit and the secondary full-bridge circuit with a simple configuration.

A first aspect of the invention provides an electric power conversion system. The electric power conversion system includes: a primary conversion circuit; a secondary conversion circuit magnetically coupled to the primary conversion circuit via a transformer; and a failure detection unit configured to detect a failure of any one of switching elements by causing each of the switching elements to switch between an on state and an off state, the switching elements constituting a full-bridge circuit of a conversion circuit to which input voltage is supplied from a corresponding one of center taps of the transformer, the full-bridge circuit being one of a primary full-bridge circuit of the primary conversion circuit and a secondary full-bridge circuit of the secondary conversion circuit.

A second aspect of the invention provides a failure detection method for an electric power conversion system including a primary conversion circuit and a secondary conversion circuit magnetically coupled to the primary conversion circuit via a transformer. The failure detection method includes: detecting a failure of any one of switching elements by causing each of the switching elements to switch between an on state and an off state, the switching elements constituting a full-bridge circuit of a conversion circuit to which input voltage is supplied from a corresponding one of center taps of the transformer, the full-bridge circuit being one of a primary full-bridge circuit of the primary conversion circuit and a secondary full-bridge circuit of the secondary conversion circuit.

According to the above aspects of the invention, it is possible to detect a failure of any one of the switching elements that constitute the primary and secondary full-bridge circuits with a simple configuration.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view of an electric power conversion system according to a first embodiment of the present invention;

FIG. 2 is a block diagram of a failure detection unit according to the embodiment;

FIG. 3 is a timing chart of voltage waveforms of full-bridge circuits;

FIG. 4 is a flowchart that shows an example of a failure detection method for the electric power conversion system according to the first embodiment;

FIG. 5 is a flowchart that shows the example of the failure detection method for the electric power conversion system according to the first embodiment;

FIG. 6 is a configuration view of an electric power conversion system according to a second embodiment of the present invention;

FIG. 7 is a flowchart that shows an example of a failure detection method for the electric power conversion system according to the second embodiment; and

FIG. 8 is a flowchart that shows the example of the failure detection method for the electric power conversion system according to the second embodiment.

### DETAILED DESCRIPTION OF EMBODIMENTS

### First Embodiment

### Configuration of Electric Power Conversion System 100

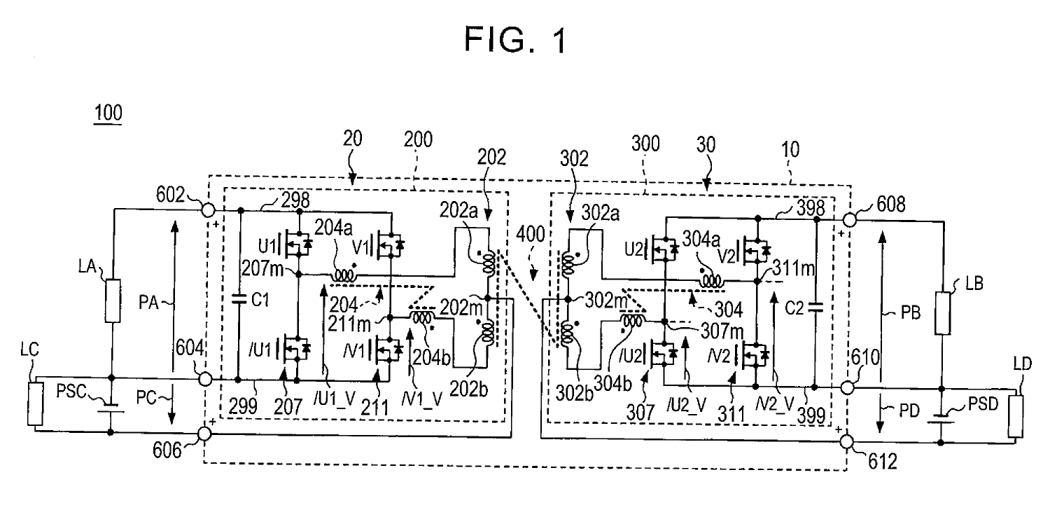

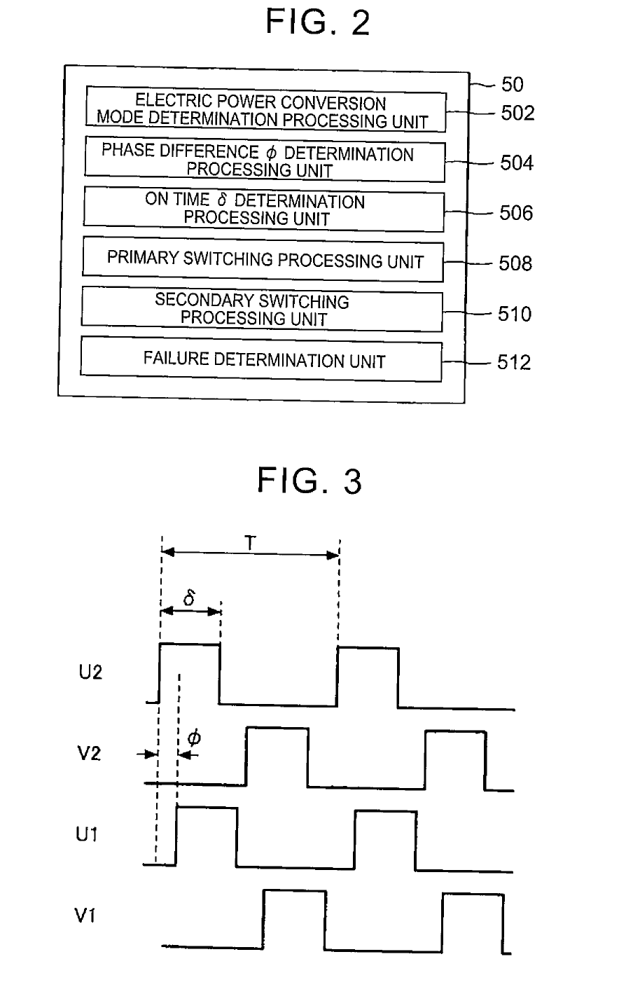

FIG. 1 is a view that shows an electric power conversion system 100 that includes an electric power conversion circuit 10. The electric power conversion system 100 is an electric power conversion system configured to include the electric power conversion circuit 10 and a control circuit 50 (see FIG. 2, and the details will be described later). The electric power conversion circuit 10 has the function of selecting any two input/output ports from among four input/output ports and converting electric power between the selected two input/output ports. The electric power conversion circuit 10 is configured to include a primary conversion circuit 20 and a secondary conversion circuit 30. The primary conversion circuit 20 and the secondary conversion circuit 30 are magnetically coupled to each other via a transformer 400 (center tap transformer).

The primary conversion circuit 20 is configured to include a primary full-bridge circuit 200, a first input/output port PA and a second input/output port PC. The primary full-bridge circuit 200 is configured to include a primary coil 202 of the transformer 400, a primary magnetic coupling reactor 204, a primary first upper arm U1, a primary first lower arm /U1, a primary second upper arm V1 and a primary second lower arm /V1. Here, the primary first upper arm U1, the primary first lower arm /U1, the primary second upper arm V1 and the primary second lower arm /V1 each are, for example, a switching element configured to include an N-channel MOSFET and a body diode that is a parasitic element of the MOSFET. A diode may be additionally connected in parallel with the MOSFET.

The primary full-bridge circuit 200 includes a primary positive electrode bus 298 and a primary negative electrode bus 299. The primary positive electrode bus 298 is connected to a high-potential terminal 602 of the first input/output port PA. The primary negative electrode bus 299 is connected to a low-potential terminal 604 of the first input/output port PA and second input/output port PC.

A primary first arm circuit 207 is connected between the primary positive electrode bus 298 and the primary negative electrode bus 299. The primary first arm circuit 207 is formed by serially connecting the primary first upper arm U1 and the primary first lower arm /U1. Furthermore, a primary second arm circuit 211 is connected between the primary positive electrode bus 298 and the primary negative electrode bus 299 in parallel with the primary first arm circuit 207. The primary second arm circuit 211 is formed by serially connecting the primary second upper arm V1 and the primary second lower arm /V1.

The primary coil 202 and the primary magnetic coupling reactor 204 are provided at a bridge portion that connects a midpoint 207m of the primary first arm circuit 207 to a midpoint 211m of the primary second arm circuit 211. A connection relationship at the bridge portion will be described in more detail. One end of a primary first reactor 204a of the primary magnetic coupling reactor 204 is connected to the midpoint 207m of the primary first arm circuit 207. One end of the primary coil 202 is connected to the other end of the primary first reactor 204a. Furthermore, one end of a primary second reactor 204b of the primary magnetic coupling reactor 204 is connected to the other end of the primary coil 202. Moreover, the other end of the primary second reactor 204b is connected to the midpoint 211m of the primary second arm circuit 211. The primary magnetic coupling reactor 204 is configured to include the primary first reactor 204a and the primary second reactor 204b magnetically coupled to the primary first reactor 204a.

The midpoint 207m is a primary first intermediate node between the primary first upper arm U1 and the primary first lower arm /U1. The midpoint 211m is a primary second intermediate node between the primary second upper arm V1 and the primary second lower arm /V1.

The first input/output port PA is a port provided between the primary positive electrode bus 298 and the primary negative electrode bus 299. The first input/output port PA is configured to include the terminal 602 and the terminal 604. The second input/output port PC is a port provided between the primary negative electrode bus 299 and a center tap 202m of the primary coil 202. The second input/output port PC is configured to include the terminal 604 and a terminal 606.

The center tap 202m is connected to the high-potential terminal 606 of the second input/output port PC. The center tap 202m is an intermediate connection point between a primary first winding 202a and a primary second winding 202b that constitute the primary coil 202.

The primary conversion circuit 20 has a capacitor C1 inserted between the primary positive electrode bus 298 and the primary negative electrode bus 299. The capacitor C1 may be provided in an internal circuit on the primary full-bridge circuit 200 side with respect to the first input/output port PA or may be provided in an external circuit on a primary high voltage system load LA side provided on the opposite side across from the primary full-bridge circuit 200 with respect to the first input/output port PA.

The electric power conversion system 100 is, for example, configured to include the primary high voltage system load LA, a primary low voltage system load LC and a primary low voltage system power supply PSC. The primary high voltage system load LA is connected to the first input/output port PA. The primary low voltage system load LC and the primary low voltage system power supply PSC are connected to the second input/output port PC. The primary low voltage system power supply PSC supplies electric power to the primary low voltage system load LC that operates at the same voltage system (for example, 12 V system) as the primary low voltage system power supply PSC. In addition, the primary low voltage system power supply PSC supplies electric power, stepped up by the primary full-bridge circuit 200, to the primary high voltage system load LA that operates at the voltage system (for example, 48 V system higher than 12 V system) different from that of the primary low voltage system power supply PSC. A specific example of the primary low voltage system power supply PSC is a secondary battery, such as a lead-acid battery.

The secondary conversion circuit 30 is configured to include a secondary full-bridge circuit 300, a third input/output port PB and a fourth input/output port PD. The secondary full-bridge circuit 300 is configured to include a secondary coil 302 of the transformer 400, a secondary magnetic coupling reactor 304, a secondary first upper arm U2, a secondary first lower arm /U2, a secondary second upper arm V2 and a secondary second lower arm /V2. Here, the secondary first upper arm U2, the secondary first lower arm /U2, the secondary second upper arm V2 and the secondary second lower arm /V2 each are, for example, a switching element configured to include an N-channel MOSFET and a body diode that is a parasitic element of the MOSFET. A diode may be additionally connected in parallel with the MOSFET.

The secondary full-bridge circuit 300 includes a secondary positive electrode bus 398 and a secondary negative electrode bus 399. The secondary positive electrode bus 398 is connected to a high-potential terminal 608 of the third input/output port PB. The secondary negative electrode bus 399 is connected to a low-potential terminal 610 of the third input/output port PB and fourth input/output port PD.

A secondary first arm circuit 307 is connected between the secondary positive electrode bus 398 and the secondary negative electrode bus 399. The secondary first arm circuit 307 is formed by serially connecting the secondary first upper arm U2 and the secondary first lower arm /U2. Furthermore, a secondary second arm circuit 311 is connected between the secondary positive electrode bus 398 and the secondary negative electrode bus 399 in parallel with the secondary first arm circuit 307. The secondary second arm circuit 311 is formed by serially connecting the secondary second upper arm V2 and the secondary second lower arm /V2.

The secondary coil 302 and the secondary magnetic coupling reactor 304 are provided at a bridge portion that connects a midpoint 307m of the secondary first arm circuit 307 to a midpoint 311m of the secondary second arm circuit 311. A connection relationship at the bridge portion will be described in more detail. One end of a secondary first reactor 304a of the secondary magnetic coupling reactor 304 is connected to the midpoint 311m of the secondary second arm circuit 311. One end of the secondary coil 302 is connected to the other end of the secondary first reactor 304a. Furthermore, one end of a secondary second reactor 304b of the secondary magnetic coupling reactor 304 is connected to the other end of the secondary coil 302. Moreover, the other end of the secondary second reactor 304b is connected to the midpoint 307m of the secondary first arm circuit 307. The secondary magnetic coupling reactor 304 is configured to include the secondary first reactor 304a and the secondary second reactor 304b magnetically coupled to the secondary first reactor 304a.

The midpoint 307m is a secondary first intermediate node between the secondary first upper arm U2 and the secondary first lower arm /U2. The midpoint 311m is a secondary second intermediate node between the secondary second upper arm V2 and the secondary second lower arm /V2.

The third input/output port PB is a port provided between the secondary positive electrode bus 398 and the secondary negative electrode bus 399. The third input/output port PB is configured to include the terminal 608 and the terminal 610. The fourth input/output port PD is a port provided between the secondary negative electrode bus 399 and a center tap 302m of the secondary coil 302. The fourth input/output port PD is configured to include the terminal 610 and a terminal 612.

The center tap 302m is connected to the high-potential terminal 612 of the fourth input/output port PD. The center tap 302m is an intermediate connection point between a secondary first winding 302a and a secondary second winding 302b that constitute the secondary coil 302.

The secondary conversion circuit 30 has a capacitor C2 inserted between the secondary positive electrode bus 398 and the secondary negative electrode bus 399. The capacitor C2 may be provided in an internal circuit on the secondary full-bridge circuit 300 side with respect to the third input/output port PB or may be provided in an external circuit on a secondary high voltage system load LB side provided on the opposite side across from the secondary full-bridge circuit 300 with respect to the third input/output port PB.

The electric power conversion system 100 is, for example, configured to include the secondary high voltage system load LB, a secondary low voltage system load LD and a secondary low voltage system power supply PSD. The secondary high voltage system load LB is connected to the third input/output port PB. The secondary low voltage system load LD and the secondary low voltage system power supply PSD are connected to the fourth input/output port PD. The secondary low voltage system power supply PSD supplies electric power to the secondary low voltage system load LD that operates at the same voltage system (for example, 72 V system higher than 12 V system or 48 V system) as the secondary low voltage system power supply PSD. In addition, the secondary low voltage system power supply PSD supplies electric power, stepped up by the secondary full-bridge circuit 300, to the secondary high voltage system load LB that operates at the voltage system (for example, 288 V system higher than 72 V system) different from that of the secondary low voltage system power supply PSD. A specific example of the secondary low voltage system power supply PSD is a secondary battery, such as a lithium ion battery.

FIG. 2 is a block diagram of the control circuit 50. The control circuit 50 has the function of executing switching control over the switching elements, such as the primary first upper arm U1, of the primary conversion circuit 20 and the switching elements, such as the secondary first upper arm U2, of the secondary conversion circuit 30. The control circuit 50 is configured to include an electric power conversion mode determination processing unit 502, a phase difference φ determination processing unit 504, an on time δ determination processing unit 506, a primary switching processing unit 508, a secondary switching processing unit 510 and a failure determination unit 512. The control circuit 50 is, for example, an electronic circuit including a microcomputer that incorporates a CPU.

The electric power conversion mode determination processing unit 502 selects and determines an operation mode from among electric power conversion modes A to L of the electric power conversion circuit 10, described below, on the basis of an external signal (not shown). The electric power conversion modes include the mode A, the mode B and the mode C. In the mode A, electric power input from the first input/output port PA is converted and output to the second input/output port PC. In the mode B, electric power input from the first input/output port PA is converted and output to the third input/output port PB. In the mode C, electric power input from the first input/output port PA is converted and output to the fourth input/output port PD.

In addition, the electric power conversion modes further include the mode D, the mode E and the mode F. In the mode D, electric power input from the second input/output port PC is converted and output to the first input/output port PA. In the mode E, electric power input from the second input/output port PC is converted and output to the third input/output port PB. In the mode F, electric power input from the second input/output port PC is converted and output to the fourth input/output port PD.

The electric power conversion modes further include the mode G, the mode H and the mode I. In the mode G, electric power input from the third input/output port PB is converted and output to the first input/output port PA. In the mode H, electric power input from the third input/output port PB is converted and output to the second input/output port PC. In the mode I, electric power input from the third input/output port PB is converted and output to the fourth input/output port PD.

Moreover, the electric power conversion modes further include the mode J, the mode K and the mode L. In the mode J, electric power input from the fourth input/output port PD is converted and output to the first input/output port PA. In the mode K, electric power input from the fourth input/output port PD is converted and output to the second input/output port PC. In the mode L, electric power input from the fourth input/output port PD is converted and output to the third input/output port PB.

The phase difference φ determination processing unit 504 has the function of setting a phase difference φ in the switching period of the switching elements between the primary conversion circuit 20 and the secondary conversion circuit 30 in order to cause the electric power conversion circuit 10 to function as a DC-DC converter circuit.

The on time δ determination processing unit 506 has the function of setting an on time δ of each of the switching elements of the primary conversion circuit 20 and secondary conversion circuit 30 in order to cause each of the primary conversion circuit 20 and the secondary conversion circuit 30 to function as a step-up/step-down circuit.

The primary switching processing unit 508 has the function of executing switching control over the switching elements, that is, the primary first upper arm U1, the primary first lower arm /U1, the primary second upper arm V1 and the primary second lower arm /V1, on the basis of outputs of the electric power conversion mode determination processing unit 502, phase difference φ determination processing unit 504 and on time δ determination processing unit 506.

The secondary switching processing unit 510 has the function of executing switching control over the switching elements, that is, the secondary first upper arm U2, the secondary first lower arm /U2, the secondary second upper arm V2 and the secondary second lower arm /V2, on the basis of the outputs of the electric power conversion mode determination processing unit 502, phase difference φ determination processing unit 504 and on time δ determination processing unit 506.

The failure determination unit 512 has the function of determining a failure mode of any one of the switching elements that constitute the primary full-bridge circuit 200 by monitoring a voltage at a predetermined portion of the primary conversion circuit 20 to which input voltage is supplied from the center tap 202m. Similarly, the failure determination unit 512 has the function of determining a failure mode of any one of the switching elements that constitute the secondary full-bridge circuit 300 by monitoring a voltage at a predetermined portion of the secondary conversion circuit 30 to which input voltage is supplied from the center tap 302m.

### Operation of Electric Power Conversion System 100

The operation of the electric power conversion system 100 will be described with reference to FIG. 1. For example, when an external signal that requires the electric power conversion circuit 10 to operate in the mode F is input, the electric power conversion mode determination processing unit 502 of the control circuit 50 determines the electric power conversion mode of the electric power conversion circuit 10 as the mode F. At this time, the voltage input to the second input/output port PC is stepped up by the step-up function of the primary conversion circuit 20, the stepped-up voltage is transferred to the third input/output port PB side by the function of the electric power conversion circuit 10 as the DC-DC converter circuit and is further stepped down by the step-down function of the secondary conversion circuit 30, and the resultant voltage is output from the fourth input/output port PD.

Here, the details of the step-up/step-down function of the primary conversion circuit 20 will be described in detail. Focusing on the second input/output port PC and the first input/output port PA, the terminal 606 of the second input/output port PC is connected to the midpoint 207m of the primary first arm circuit 207 via the primary first winding 202a and the primary first reactor 204a serially connected to the primary first winding 202a. Both ends of the primary first arm circuit 207 are connected to the first input/output port PA, with the result that a step-up/step-down circuit is connected between the terminal 606 of the second input/output port PC and the first input/output port PA.

Furthermore, the terminal 606 of the second input/output port PC is connected to the midpoint 211m of the primary second arm circuit 211 via the primary second winding 202b and the primary second reactor 204b serially connected to the primary second winding 202b. Both ends of the primary second arm circuit 211 are connected to the first input/output port PA, with the result that a step-up/step-down circuit is connected between the terminal 606 of the second input/output port PC and the first input/output port PA in parallel with the above-described step-up/step-down circuit. The secondary conversion circuit 30 is a circuit having a substantially similar configuration to that of the primary conversion circuit 20, with the result that two step-up/step-down circuits are connected in parallel with each other between the terminal 612 of the fourth input/output port PD and the third input/output port PB. Thus, the secondary conversion circuit 30 has a similar step-up/step-down function to that of the primary conversion circuit 20.

Next, the function of the electric power conversion circuit 10 as the DC-DC converter circuit will be described in detail. Focusing on the first input/output port PA and the third input/output port PB, the primary full-bridge circuit 200 is connected to the first input/output port PA, and the secondary full-bridge circuit 300 is connected to the third input/output port PB. The primary coil 202 provided at the bridge portion of the primary full-bridge circuit 200 and the secondary coil 302 provided at the bridge portion of the secondary full-bridge circuit 300 are magnetically coupled to each other, thus functioning as the transformer 400 (the center tap transformer having a winding number ratio of 1:N). Thus, by adjusting the phase difference of the switching period of the switching elements between the primary full-bridge circuit 200 and the secondary full-bridge circuit 300, it is possible to convert electric power input to the first input/output port PA and transfer the electric power to the third input/output port PB or convert electric power input to the third input/output port PB and transfer the electric power to the first input/output port PA.

FIG. 3 is a view that shows a timing chart regarding voltages supplied to the electric power conversion circuit 10 through control over the control circuit 50. In FIG. 3, U1 indicates an on/off waveform of the primary first upper arm U1, V1 indicates an on/off waveform of the primary second upper arm V1, U2 is an on/off waveform of the secondary first upper arm U2, and V2 is an on/off waveform of the secondary second upper arm V2. On/off waveforms of the primary first lower arm /U1, primary second lower arm /V1, secondary first lower arm /U2 and secondary second lower arm /V2 are respectively waveforms inverted from the on/off waveforms of the primary first upper arm U1, primary second upper arm V1, secondary first upper arm U2 and secondary second upper arm V2 (not shown). It is desirable that a dead time be provided between both on/off waveforms of each pair of upper and lower arms such that no flow-through current flows as a result of the on states of both upper and lower arms. In FIG. 3, the high level indicates the on state, and the low level indicates the off state.

Here, by changing the on time δ of each of U1, V1, U2, V2, it is possible to change a step-up/step-down ratio of the primary conversion circuit 20 and a step-up/step-down ratio of the secondary conversion circuit 30. For example, by equalizing the on time δ of each of U1, V1, U2, V2 to one another, it is possible to equalize the step-up/step-down ratio of the primary conversion circuit 20 to the step-up/step-down ratio of the secondary conversion circuit 30. The phase difference between U1 and V1 is set to 180 degrees (π), and the phase difference between U2 and V2 is also set to 180 degrees (π). Furthermore, by changing the phase difference φ between U1 and U2, it is possible to adjust the amount of electric power transferred between the primary conversion circuit 20 and the secondary conversion circuit 30. When the phase difference φ is larger than 0, it is possible to transfer electric power from the primary conversion circuit 20 to the secondary conversion circuit 30; whereas, when the phase difference φ is smaller than 0, it is possible to transfer electric power from the secondary conversion circuit 30 to the primary conversion circuit 20.

Thus, for example, when an external signal that requires the electric power conversion circuit 10 to operate in the mode F is input, the electric power conversion mode determination processing unit 502 determines to select the mode F. The on time δ determination processing unit 506 sets the on time δ that prescribes the step-up ratio in the case where the primary conversion circuit 20 is caused to function as a step-up circuit that steps up voltage input to the second input/output port PC and outputs the stepped-up voltage to the first input/output port PA. The secondary conversion circuit 30 functions as a step-down circuit that steps down voltage input to the third input/output port PB at the step-down ratio prescribed by the on time δ set by the on time δ determination processing unit 506 and outputs the stepped-down voltage to the fourth input/output port PD. Furthermore, the phase difference φ determination processing unit 504 sets the phase difference φ for transferring electric power, input to the first input/output port PA, to the third input/output port PB at a desired amount of electric power transferred.

The primary switching processing unit 508 executes switching control over the switching elements, that is, the primary first upper arm U1, the primary first lower arm /U1, the primary second upper arm V1 and the primary second lower arm /V1, such that the primary conversion circuit 20 is caused to function as the step-up circuit and the primary conversion circuit 20 is caused to function as part of the DC-DC converter circuit.

The secondary switching processing unit 510 executes switching control over the switching elements, that is, the secondary first upper arm U2, the secondary first lower arm /U2, the secondary second upper arm V2 and the secondary second lower arm /V2, such that the secondary conversion circuit 30 is caused to function as the step-down circuit and the secondary conversion circuit 30 is caused to function as part of the DC-DC converter circuit.

As described above, it is possible to cause each of the primary conversion circuit 20 and the secondary conversion circuit 30 to function as the step-up circuit or the step-down circuit, and it is possible to cause the electric power conversion circuit 10 to also function as the bidirectional DC-DC converter circuit. Thus, it is possible to convert electric power in all of the electric power conversion modes A to L, in other words, it is possible to convert electric power between the two input/output ports selected from among the four input/output ports.

### Failure Detection of Electric Power Conversion System 100

The control circuit 50 shown in FIG. 2 is a failure detection unit that detects a failure of any one of the switching elements by causing each of the switching elements to switch between the on state and the off state. The switching elements constitute the primary full-bridge circuit 200 of the primary conversion circuit 20 to which input voltage is supplied from the center tap 202m of the transformer 400. As shown in FIG. 1, the input voltage supplied from the center tap 202m corresponds to the power supply voltage of the primary low voltage system power supply PSC, and is applied to the center tap 202m via the second input/output port PC.

The control circuit 50 shown in FIG. 2 is a failure detection unit that detects a failure of any one of the switching elements by causing each of the switching elements to switch between the on state and the off state. The switching elements constitute the secondary full-bridge circuit 300 of the secondary conversion circuit 30 to which input voltage is supplied from the center tap 302m of the transformer 400. As shown in FIG. 1, the input voltage supplied from the center tap 302m corresponds to the power supply voltage of the secondary low voltage system power supply PSD, and is applied to the center tap 302m via the fourth input/output port PD.

The control circuit 50, for example, determines one of the primary full-bridge circuit 200 and the secondary full-bridge circuit 300, to which the input voltage is supplied from the corresponding one of the center taps of the transformer 400, by monitoring a supply state of the input voltage supplied from the center tap 202m or center tap 302m of the transformer 400. The control circuit 50, for example, detects a failure of any one of the switching elements that constitute the one of the full-bridge circuits, which is determined to be supplied with the input voltage from the corresponding center tap of the transformer 400, by causing each of the switching elements to switch between the on state and the off state.

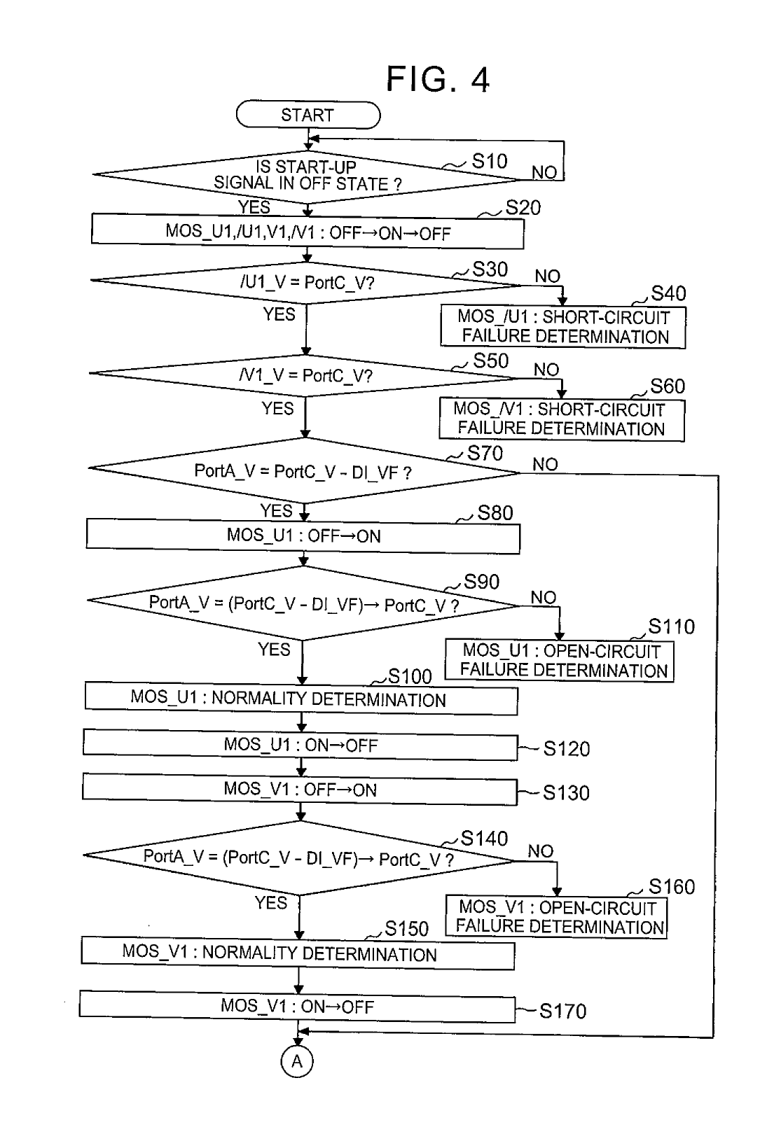

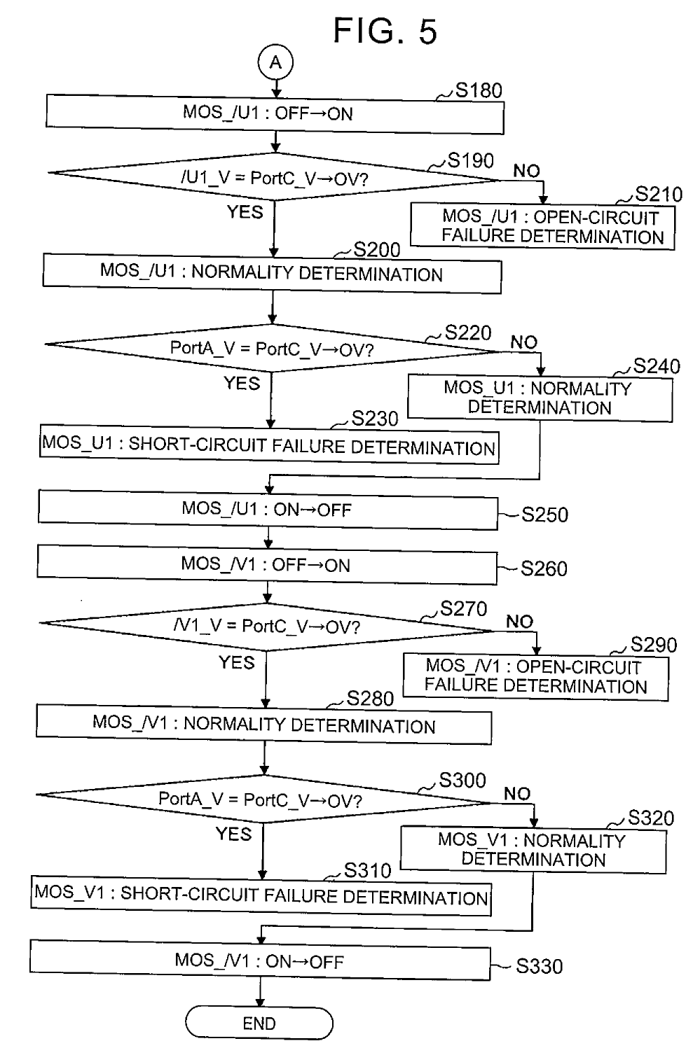

FIG. 4 and FIG. 5 show a flowchart that is an example of a failure detection method for the electric power conversion system 100. The flowchart shows the flow of determining a failure mode of each of the four switching elements that constitute the primary full-bridge circuit 200. The flow of determining a failure mode of each of the four switching elements that constitute the secondary full-bridge circuit 300 is also similar to that of FIG. 4 and FIG. 5, so the description thereof is omitted.

In the failure detection method, the failure determination unit 512 (see FIG. 2) of the control circuit 50 supplies the input voltage from only any one of the center taps of the transformer 400, and monitors the voltage at the corresponding predetermined portion by sequentially causing each of the switching elements to switch between the on state and the off state, thus determining a failure mode of each of the switching elements. Hereinafter, steps in FIG. 4 and FIG. 5 will be described.

In FIG. 4, in step S10, the control circuit 50 determines whether a start-up signal of the conversion circuit 10 is in an off state. When the start-up signal of the conversion circuit 10 is not in the off state, the control circuit 50 does not execute failure detection operation for the switching elements because the conversion circuit 10 carries out electric power conversion operation or may carry out electric power conversion operation. On the other hand, when the start-up signal of the conversion circuit 10 is in the off state, the control circuit 50 executes failure detection operation for the switching elements because the conversion circuit 10 does not carry out electric power conversion operation.

In step S20, the control circuit 50 outputs command signals for causing each of the switching elements of the primary first upper arm U1 (MOS_U1), primary first lower arm /U1 (MOS_/U1), primary second upper arm V1 (MOS_V1) and primary second lower arm /V1 (MOS_/V1) to switch from the off state to the on state, and outputs command signals for causing each of the switching elements to switch from the on state to the off state after a predetermined period of time has elapsed from when each of the switching elements is caused to switch into the on state. Thus, electric charge in the capacitor C1 is discharged, and it is possible to accurately carry out failure detection operation thereafter.

In step S30, when the commands for causing the switching elements to turn off have been issued in step S20, the failure determination unit 512 determines whether the monitored voltage (/U1_V) of the primary first lower arm /U1 is equal to the monitored voltage (PortC_V) of the second input/output port PC.

The voltage (/U1_V) corresponds to the voltage at the midpoint 207m, and, for example, corresponds to a potential difference between the midpoint 207m and the terminal 604 (primary negative electrode bus 299). The voltage (PortC_V) corresponds to the voltage at the terminal 606, and, for example, corresponds to a potential difference between the terminal 606 and the terminal 604.

When the primary first lower arm /U1 has turned off in accordance with the command, the monitored voltage (/U1_V) is equal to the voltage (PortC_V). Thus, when the monitored voltage (/U1_V) is different from the monitored voltage (PortC_V), the failure determination unit 512 understands that the primary first lower arm /U1 is in the on state against the off command, and determines that the primary first lower arm /U1 has a short-circuit failure (step S40).

In step S50, when the commands for causing the switching elements to turn off have been issued in step S20, the failure determination unit 512 determines whether the monitored voltage (/V1_V) of the primary second lower arm /V1 is equal to the monitored voltage (PortC_V) of the second input/output port PC.

The voltage (/V1_V) corresponds to the voltage at the midpoint 211m, and, for example, corresponds to a potential difference between the midpoint 211m and the terminal 604 (primary negative electrode bus 299).

When the primary second lower arm /V1 has turned off in accordance with the command, the monitored voltage (/V1_V) is equal to the voltage (PortC_V). Thus, when the monitored voltage (/V1_V) is different from the monitored voltage (PortC_V), the failure determination unit 512 understands that the primary second lower arm /V1 is in the on state against the off command, and determines that the primary second lower arm /V1 has a short-circuit failure (step S60).

In step S70, when the commands for causing the switching elements to turn off have been issued in step S20, the failure determination unit 512 determines whether the monitored voltage (PortA_V) of the first input/output port PA is equal to a voltage obtained by subtracting the forward voltage (DI_VF) of the diode from the monitored voltage (PortC_V).

The voltage (PortA_V) corresponds to the voltage at the terminal 602 (primary positive electrode bus 298), and, for example, corresponds to a potential difference between the terminal 602 and the terminal 604.

If the primary first upper arm U1 and the primary second upper arm V1 have turned off in accordance with the commands in step S20, current flows through the diode connected in parallel with the primary first upper arm U1 and the diode connected in parallel with the primary second upper arm V1. When current flows through the diodes, the monitored voltage (PortA_V) is equal to the voltage obtained by subtracting the forward voltage (DI_VF) from the monitored voltage (PortC_V). That is, it may be determined that the primary first upper arm U1 and the primary second upper arm V1 have no short-circuit failure.

On the other hand, in step S70, when the monitored voltage (PortA_V) is different from the voltage obtained by subtracting the forward voltage (DI_VF) from the monitored voltage (PortC_V), at least one of the primary first upper arm U1 and the primary second upper arm V1 may have a short-circuit failure. In this case, the failure detection operation is skipped to step S180 of FIG. 5 (described later).

In step S80 of FIG. 4, the control circuit 50 outputs the command signal for causing the primary first upper arm U1 to switch from the off state to the on state when the voltages are equal to each other in step S70.

In step S90, the failure determination unit 512 determines whether the monitored voltage (PortA_V) has varied from the voltage, obtained by subtracting the forward voltage (DI_VF) from the monitored voltage (PortC_V), to the monitored voltage (PortC_V) in response to the command in step S80.

When a variation in the monitored voltage (PortA_V) has been detected, the failure determination unit 512 understands that the primary first upper arm U1 has switched into the on state in accordance with the command, and determines that the primary first upper arm U1 is normal (step S100). On the other hand, when no variation in the monitored voltage (PortA_V) has been detected, the failure determination unit 512 understands that the primary first upper arm U1 remains in the off state against the on command, and determines that the primary first upper arm U1 has an open-circuit failure (step S110).

In step S120, the control circuit 50 outputs the command signal for causing the primary first upper arm U1 to switch from the on state to the off state.

In step S130 to step S170, the control circuit 50 and the failure determination unit 512 carry out normality determination and open-circuit failure determination for the primary second upper arm V1 as in the case of the primary first upper arm U1 in step S80 to step S120.

In FIG. 5, in step S180, the control circuit 50 outputs the command signal for causing the primary first lower arm /U1 to switch from the off state to the on state.

In step S190, the failure determination unit 512 determines whether the monitored voltage (/U1_V) has varied from the monitored voltage (PortC_V) to the voltage 0 V at the time when the primary first lower arm /U1 is in the on state in response to the command in step S180. The voltage at the time when the primary first lower arm /U1 is in the on state is not limited to 0 V and may be a micro-voltage close to 0 V.

When a variation in the monitored voltage (/U1_V) has been detected (when the monitored voltage (/U1_V) is equal to the voltage 0 V), the failure determination unit 512 understands that the primary first lower arm /U1 has switched into the on state in accordance with the command, and determines that the primary first lower arm /U1 is normal (step S200). On the other hand, when no variation in the monitored voltage (/U1_V) has been detected (when the monitored voltage (/U1_V) is different from the voltage 0 V), the failure determination unit 512 understands that the primary first lower arm /U1 remains in the off state against the on command, and determines that the primary first lower arm /U1 has an open-circuit failure (step S210).

In step S220, the failure determination unit 512 determines whether the monitored voltage (PortA_V) has varied from the monitored voltage (PortC_V) to the voltage 0 V at the time when the primary first lower arm /U1 is in the on state in response to the command in step S180.

When the primary first upper arm U1 remains in the on state against the off command, the monitored voltage (PortA_V) is equal to the voltage 0 V at the time when the primary first lower arm /U1 is in the on state because of the on state of the primary first lower arm /U1. Thus, when a variation in the monitored voltage (PortA_V) has been detected (when the monitored voltage (PortA_V) is equal to the voltage 0 V), the failure determination unit 512 determines that the primary first upper arm U1 has a short-circuit failure (step S230). On the other hand, when no variation in the monitored voltage (PortA_V) has been detected (when the monitored voltage (PortA_V) is different from the voltage 0 V), the failure determination unit 512 determines that the primary first upper arm U1 is normal (step S240).

In step S250, the control circuit 50 outputs the command signal for causing the primary first lower arm /U1 to switch from the on state to the off state.

In step S260 to step S330, the control circuit 50 and the failure determination unit 512 carry out normality determination and open-circuit failure determination for the primary second lower arm /V1 and normality determination and short-circuit failure determination for the primary second upper arm V1 as in the case of the primary first lower arm /U1 and the primary first upper arm U1 in step S180 to step S250.

After the failure detection operation for the primary full-bridge circuit 200 has been completed, failure detection operation for the secondary full-bridge circuit 300 should be started as in the case of the above manner. The failure detection operation for the primary full-bridge circuit 200 may be started after the failure detection operation for the secondary full-bridge circuit 300 has been completed.

According to the present embodiment, it is possible to detect a failure of any one of the switching elements that constitute the primary full-bridge circuit 200 and the secondary full-bridge circuit 300 with a simple configuration. That is, the electric power conversion system 100 converts electric power with the use of the primary low voltage system power supply PSC connected to the second input/output port PC and the secondary low voltage system power supply PSD connected to the fourth input/output port PD. In the present embodiment, the primary low voltage system power supply PSC and the secondary low voltage system power supply PSD that are used together to convert electric power are also utilized to detect a failure. Thus, it is possible to detect a failure with a simple configuration by minimizing addition of a circuit for failure detection.

### Second Embodiment

### Configuration of Electric Power Conversion System 101

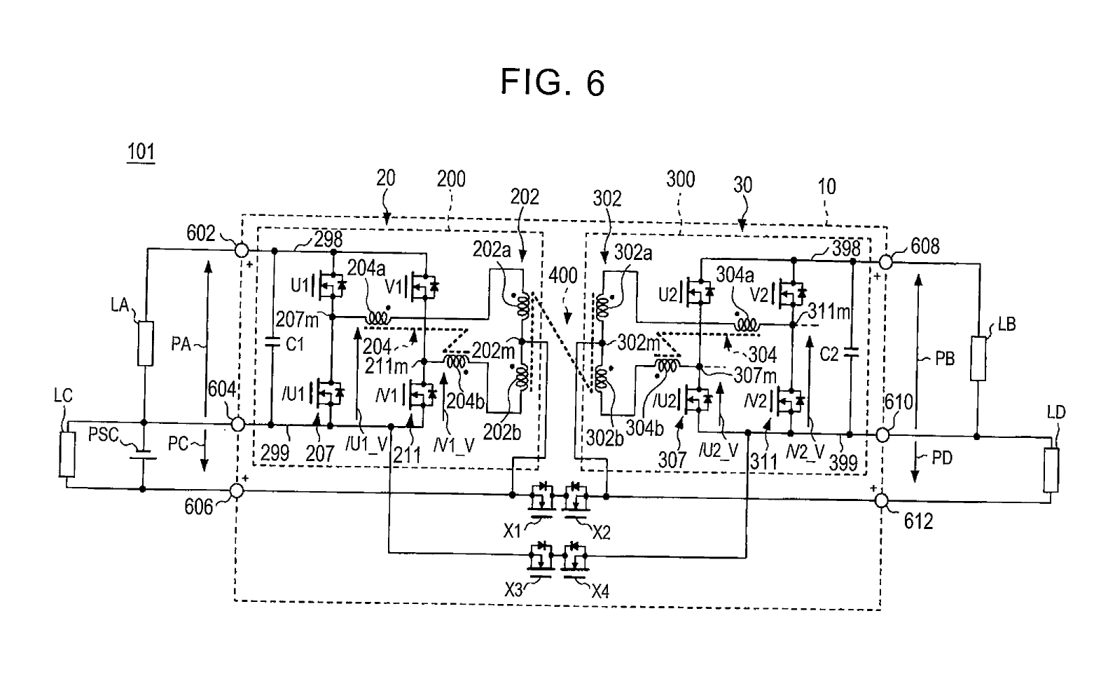

FIG. 6 is a view that shows an electric power conversion system 101 that includes the electric power conversion circuit 10. The description of a configuration similar to that of the first embodiment is omitted.

The electric power conversion system 101 includes only the primary low voltage system power supply PSC (does not include the secondary low voltage system power supply PSD) as a power supply that supplies input voltage to the center taps 202m, 302m of the transformer 400. In addition, the electric power conversion system 101 includes switching elements X1, X2, X3, X4 as an interrupting device that interrupts supply of the input voltage from the primary low voltage system power supply PSC to the center tap 302m of the transformer 400. Each of the switching elements X1, X2, X3, X4 is, for example, caused to switch between an on state and an off state by a command signal from the control circuit 50 (see FIG. 2).

In FIG. 6, the switching elements X1, X2 are serially inserted in a positive, electrode bus that connects the terminal 606 to the terminal 612. The center tap 302m is connected to the terminal 606 via the switching elements X1, X2. The center tap 202m is connected to the terminal 612 via the switching elements X1, X2. By turning off the switching element X2, it is possible to prevent current from flowing from the primary side to the secondary side via the parasitic diode of the switching element X1. By turning off the switching element X1, it is possible to prevent current from flowing from the secondary side to the primary side via the parasitic diode of the switching element X2.

The switching elements X3, X4 are serially inserted in a negative electrode bus that connects the primary negative electrode bus 299 to the secondary negative electrode bus 399. By turning off the switching element X4, it is possible to prevent current from flowing from the primary side to the secondary side via the parasitic diode of the switching element X3. By turning off the switching element X3, it is possible to prevent current from flowing from the secondary side to the primary side via the parasitic diode of the switching element X4.

When failure detection operation for the switching elements that constitute the primary full-bridge circuit 200 and the secondary full-bridge circuit 300 is not carried out or when the failure detection operation for the switching elements that constitute the primary full-bridge circuit 200 is carried out, the switching elements X1, X2, X3, X4 are turned off. On the other hand, when the failure detection operation for the switching elements that constitute the secondary full-bridge circuit 300, the switching elements X1, X2, X3, X4 turn on.

Because the interrupting device, that is, the switching elements X1, X2, X3, X4, is provided, it is possible to detect a failure of any one of the switching elements that constitute the secondary full-bridge circuit 300 with the use of only the primary low voltage system power supply PSC without influence on normal operation, such as the electric power conversion operation, of the conversion circuit 10.

### Failure Detection for Electric Power Conversion System 101

The control circuit 50 shown in FIG. 2 is a failure detection unit that detects a failure of any one of the switching elements by causing each of the switching elements to switch between the on state and the off state. The switching elements constitute the secondary full-bridge circuit 300 of the secondary conversion circuit 30 to which input voltage is supplied from the center tap 302m of the transformer 400. As shown in FIG. 6, the input voltage supplied from the center tap 302m corresponds to the power supply voltage of the primary low voltage system power supply PSC, and is applied to the center tap 302m via the second input/output port PC and the switching elements X1, X2, X3, X4.

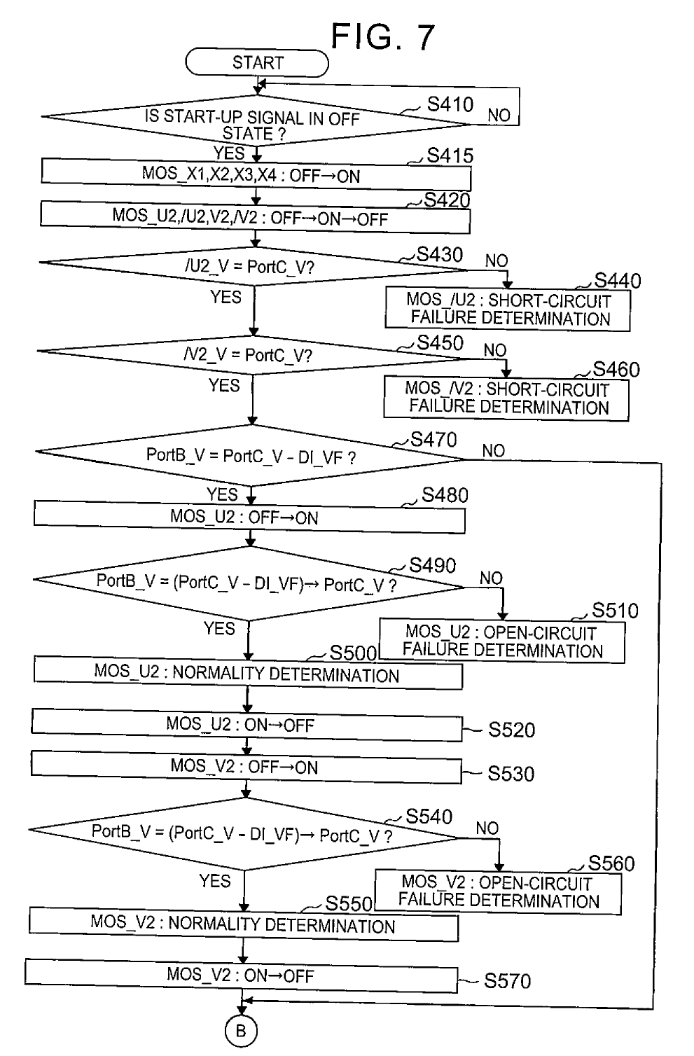

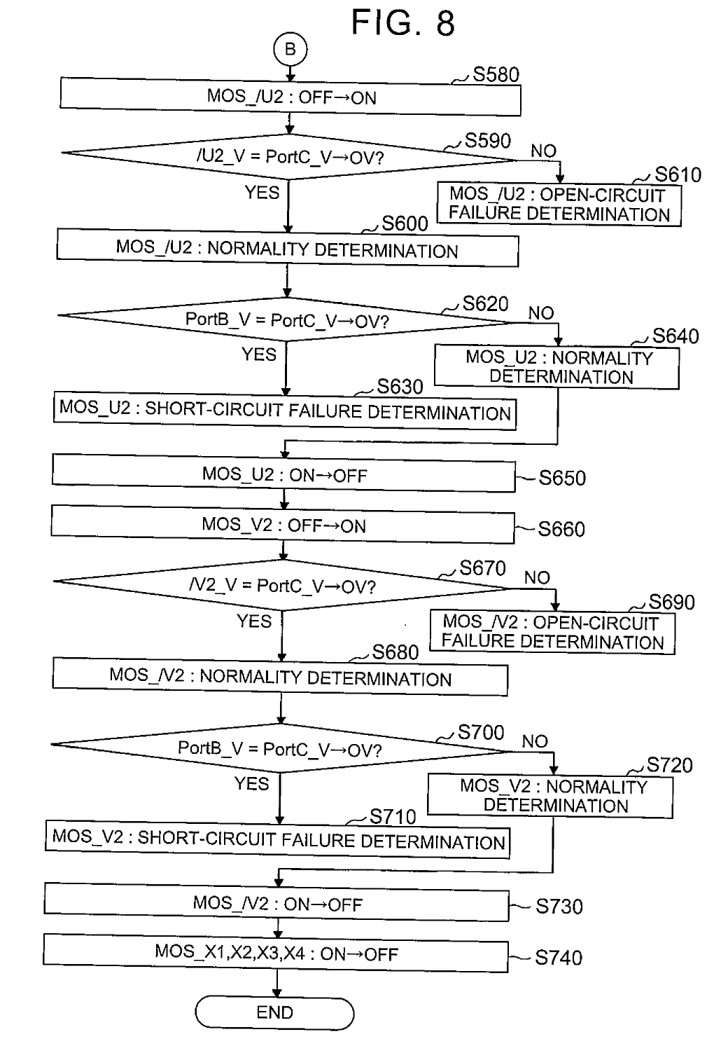

FIG. 7 and FIG. 8 show a flowchart that is an example of a failure detection method for the electric power conversion system 101. The flowchart shows the flow of determining a failure mode of any one of the four switching elements that constitute the secondary full-bridge circuit 300. The flow of determining a failure mode of any one of the four switching elements that constitute the primary full-bridge circuit 200 is similar to that shown in FIG. 4 and FIG. 5, so the description thereof is omitted. In addition, hereinafter, steps in FIG. 7 and FIG. 8 will be described; however, the description of steps having similar operations to those of FIG. 4 and FIG. 5 is omitted or simplified.

In FIG. 7, in step S410, the control circuit 50 determines whether the start-up signal of the conversion circuit 10 is in the off state.

In step S415, the control circuit 50 outputs command signals for causing the switching elements X1, X2, X3, X4 (MOS_X1,X2,X3,X4) to switch from the off state to the on state. Thus, it is possible to supply the electric power of the primary low voltage system power supply PSC to the secondary-side center tap 302m. As a result, the failure detection operation for the switching elements that constitute the secondary full-bridge circuit 300 is allowed with the use of the power supply voltage of the primary low voltage system power supply PSC.

Step S420 is similar to step S20 in FIG. 4. That is, the control circuit 50 outputs command signals for causing each of the switching elements of the secondary first upper arm U2 (MOS_U2), secondary first lower arm /U2 (MOS_/U2), secondary second upper arm V2 (MOS_V2) and secondary second lower arm /V2 (MOS_/V2) to switch from the off state to the on state, and outputs command signals for causing each of the switching elements to switch from the on state to the off state after a predetermined period of time has elapsed from when each of the switching elements is caused to switch into the on state. Thus, electric charge in the capacitor C2 is discharged, and it is possible to accurately carry out failure detection operation thereafter.

Step S430 and step S440 are similar to step S30 and step S40 shown in FIG. 4. Thus, it is possible to determine whether the secondary first lower arm /U2 has a short-circuit failure. The voltage (/U2_V) corresponds to the voltage at the midpoint 307m, and, for example, corresponds to a potential difference between the midpoint 307m and the terminal 604 (primary negative electrode bus 299).

Step S450 and step S460 are similar to step S50 and step S60 in FIG. 4. Thus, it is possible to determine whether the secondary second lower arm /V2 has a short-circuit failure. The voltage (/V2_V) corresponds to the voltage at the midpoint 311m, and, for example, corresponds to a potential difference between the midpoint 311m and the terminal 604 (primary negative electrode bus 299).

Step S470 is similar to step S70 in FIG. 4. The voltage (PortB_V) corresponds to the voltage at the terminal 608 (secondary positive electrode bus 398), and, for example, corresponds to a potential difference between the terminal 608 and the terminal 610.

In step S480 to step S520, the control circuit 50 and the failure determination unit 512 carry out normality determination and open-circuit failure determination for the secondary first upper arm U2 as in the case of the primary first upper arm U1 in step S80 to step S120 in FIG. 4.

In step S530 to step S570, the control circuit 50 and the failure determination unit 512 carry out normality determination and open-circuit failure determination for the secondary second upper arm V2 as in the case of the primary first upper arm U1 in step S80 to step S120 in FIG. 4.

In FIG. 8, in step S580 to step S650, the control circuit 50 and the failure determination unit 512 carry out normality determination and open-circuit failure determination for the secondary first lower arm /U2 and normality determination and short-circuit failure determination for the secondary first upper arm U2 as in the case of the primary first lower arm /U1 and the primary first upper arm U1 in step S180 to step S250 in FIG. 4.

In step S660 to step S730, the control circuit 50 and the failure determination unit 512 carry out normality determination and open-circuit failure determination for the secondary second lower arm /V2 and normality determination and short-circuit failure determination for the secondary second upper arm V2 as in the case of the primary first lower arm /U1 and the primary first upper arm U1 in step S180 to step S250 in FIG. 4.

In step S740, the control circuit 50 outputs the command signals for causing the switching elements X1, X2, X3, X4 to switch from the on state to the off state.

According to the present embodiment, it is possible to detect a failure of any one of the switching elements that constitute the primary full-bridge circuit 200 and the secondary full bridge circuit 300 with a simple configuration. That is, the electric power conversion system 101 converts electric power with the use of the primary low voltage system power supply PSC connected to the second input/output port PC. In the present embodiment, the primary low voltage system power supply PSC that is used to convert electric power is also utilized to detect a failure. Thus, it is possible to detect a failure with a simple configuration by minimizing addition of a circuit for failure detection.

The electric power conversion system and the failure detection method for an electric power conversion system are described by way of the embodiments; however, the invention is not limited to the above-described embodiments. The scope of the invention encompasses various modifications and improvements, such as combinations and replacements of the above-described embodiments with part or all of another embodiment.

For example, in the above-described embodiments, the MOSFET that is a semiconductor element that carries out on/off operation is described as an example of each switching element. However, each switching element may be, for example, a voltage-controlled power element with an insulated gate, such as an IGBT and a MOSFET, or may be a bipolar transistor.

What is claimed is:

1. An electric power conversion system comprising:
a primary conversion circuit;
a secondary conversion circuit magnetically coupled to the primary conversion circuit via a transformer; and
a failure detection unit configured to detect a failure of any one of switching elements by causing each of the switching elements to switch between an on state and an off state, the switching elements constituting a full-bridge circuit of a conversion circuit to which input voltage is supplied from a corresponding one of center taps of the transformer, the full-bridge circuit being one of a primary full-bridge circuit of the primary conversion circuit and a secondary full-bridge circuit of the secondary conversion circuit.

2. The electric power conversion system according to claim 1, wherein
the failure detection unit is configured to determine whether any one of the switching elements has a failure by monitoring a voltage at a predetermined portion of the conversion circuit to which the input voltage is supplied.

3. The electric power conversion system according to claim 2, wherein
the predetermined portion includes an intermediate node between each pair of the high-side switching element and the low-side switching element that constitute the full-bridge circuit.

4. The electric power conversion system according to claim 3, wherein
the failure detection unit is configured to, when a command for causing one of the low-side switching elements to switch into the off state is issued and the voltage at the corresponding intermediate node is different from the input voltage, determine that the one of the low-side switching elements has a short-circuit failure.

5. The electric power conversion system according to claim 3, wherein
the failure detection unit is configured to, when a command for causing one of the low-side switching elements to switch into the on state is issued and the voltage at the corresponding intermediate node is different from a voltage at the time when the one of the low-side switching elements in the on state, determine that the one of the low-side switching elements has an open-circuit failure.

6. The electric power conversion system according to claim 2, wherein
the predetermined portion includes a positive electrode bus of the full-bridge circuit.

7. The electric power conversion system according to claim 6, wherein
the failure detection unit is configured to, when a command for causing one of the high-side switching elements of the full-bridge circuit to switch into the on state is issued and the voltage at the positive electrode bus is different from the input voltage, determine that the one of the high-side switching elements has an open-circuit failure.

8. The electric power conversion system according to claim 6, wherein
the failure detection unit is configured to, when a command for causing one of the low-side switching elements of the full-bridge circuit to switch into the on state is issued and the voltage at the positive electrode bus is equal to a voltage at the time when the one of the low-side switching elements is in the on state, determine that a corresponding one of the high-side switching elements of the full-bridge circuit has a short-circuit failure.

9. The electric power conversion system according to claim 1, further comprising:
a power supply configured to supply the input voltage to the center taps of the transformer; and
an interrupting device configured to interrupt supply of the input voltage from the power supply to one of the center taps of the transformer.

10. A failure detection method for an electric power conversion system including a primary conversion circuit and a secondary conversion circuit magnetically coupled to the primary conversion circuit via a transformer, comprising:
detecting a failure of any one of switching elements by causing each of the switching elements to switch between an on state and an off state, the switching elements constituting a full-bridge circuit of a conversion circuit to which input voltage is supplied from a corresponding one of center taps of the transformer, the full-bridge circuit being one of a primary full-bridge circuit of the primary conversion circuit and a secondary full-bridge circuit of the secondary conversion circuit.
